(19) United States
(12) Patent Application Publication
(10) Pub. No.: US 2025/0143277 A1
(43) Pub. Date: May 8, 2025

(54) A MOSQUITO TRAP

(71) Applicant: Haim SHAHAR, Haifa (IL)

(72) Inventor: Haim SHAHAR, Haifa (IL)

(21) Appl. No.: 18/694,050

(22) PCT Filed: Sep. 23, 2021
(86) PCT No.: PCT/IL2021/051156

§ 371 Date: Mar. 21, 2024

(51) Int. Cl. A01M 1/02; A01M 1/22

(52) U.S. Cl. CPC A01M 1/023; A01M 1/223

(57) ABSTRACT

A mosquito trap, comprising a container adapted with a lower portion containing an alcohol-based liquid and with a top portion from which a capillary stick extends downwardly, such as that its bottom end is immersed in the alcohol-based liquid and its top-end protrudes upwardly and being limited by a mesh of a lid, which is detachably connected to the container. The lid further comprises circumferential inlet holes that enable incoming ambient airflow into the mosquito trap; a hot reactor unit connected to the lid, comprising an enclosure adapted with peripheral air inlet holes, a lower inlet mesh, a top outlet mesh, and a substantially hollow reaction chimney adapted with lower and upper apertures, a heating module for heating the lower portion of said chimney, and a sensing/switching module for shutting off said heating module upon reaching a predetermined temperature. The chimney further comprises a catalyst that accelerates a reaction between vaporized alcohol-based liquid from said container and oxygen from the incoming ambient air; an elimination module attached to the reactor unit, comprising a dispersion sleeve which receives and disperse reaction products from said hot reactor to the ambient environment for attracting mosquitos, and an electric elimination means for eliminating mosquitos attracted to said mosquito trap.

### FIELD OF THE INVENTION

The present invention relates to the field of insects traps. More specifically, the invention relates to an environmental friendly mosquito trap.

### BACKGROUND OF THE INVENTION

Mosquitoes create a high level of nuisance and are a source of many major complaints submitted to municipalities in different countries. Mosquitoes also pose a danger to public health as every year about million people die from diseases caused by mosquitoes and tens of millions of people become infected with malaria alone (a disease which is transferred to humans by mosquitoes). Other serious illnesses caused by mosquitoes: Dengue fever, Yellow fever, Chikungunya, Zika, West Nile fever and others. Therefore, there is a continuous need to trap and kill mosquitoes.

In the past, air has been sprayed in cities against adult mosquitoes using pesticides, but this solution caused more damage than benefit. For many decades now, the market offers mosquito traps intended to attract and then eliminate mosquitos. These traps are commonly based on inducing an attractive environment, such as by dispersing CO2, heat, odors and water vapors (so as to simulate the environment in the human body).

However, the operation of the abovementioned mosquito traps is based on chemicals that are not environmentally friendly, dispersing unpleasant odors, and constant power supply for heating and/or ventilating odor generating substance. Moreover, the existing mosquito traps fail to accurately simulate the environment of the human body, or to induce the required conditions for mosquitos to prefer the mosquito trap over nearby humans.

Therefore, it is an object of the present invention to provide a compact, low-cost and environmental-friendly mosquito trap.

It is another object of the present invention to provide a mosquito trap, operation of which does not require a constant power supply.

It is yet another object of the present invention to provide a mosquito trap, which effectively attracts mosquitos.

Other objects and advantages of the invention will become apparent as the description proceeds.

### SUMMARY OF THE INVENTION

In one aspect, the invention relates to a mosquito trap, comprising: a) a container adapted with a lower portion containing an alcohol-based liquid and with a top portion from which a capillary transmission means extends downwardly, such as that its bottom end is immersed in the alcohol-based liquid to a determined extent, and its top end, which is wet with capillary transmitted alcohol-based liquid, protrudes upwardly and being limited by a mesh of a lid, detachably connected to the container, wherein the lid further comprises circumferential inlet holes that enable incoming ambient air flow into the mosquito trap, and wherein said lid is adapted to detachably connect to a hot reactor, b) a reactor unit adapted with a hot reactor, comprising an enclosure adapted with peripheral air inlet holes, a lower inlet mesh, a top outlet mesh, and a substantially hollow reaction chimney adapted with lower and upper apertures, a heating module for heating the lower portion of said chimney, and a sensing/switching module for shutting of said heating module upon reaching a predetermined temperature, wherein said chimney further comprises a catalyst that is suitable for accelerating a reaction between vaporized alcohol-based liquid from said container and oxygen from the incoming ambient air, and wherein said reactor unit is further adapted to be attached with an elimination module, and c) an elimination module adapted to be attached with a reactor unit, comprising a dispersion sleeve which receives and disperse reaction products from said hot reactor to the ambient environment for attracting mosquitos, and an electric elimination means for eliminating mosquitos attracted to said mosquito trap, wherein the operation of said mosquito trap begins with the powering of said heating module which exerts sufficient heat at the lower portion of said chimney to initiate the reaction of vapors of said alcohol-based liquid with oxygen of the incoming ambient air, while said catalysts within said chimney accelerates the reaction resulting in CO₂, water vapors and heat being emitted towards said dispersion sleeve of said elimination module, thereby inducing mosquito-attracting ambient environment, and attracting nearby mosquitos to approach said dispersion sleeve and engage the elimination means of said elimination module.

According to an embodiment of the invention, the capillary capillary transmission means is a cotton wrapped stick, or any capillary material formed as a stick.

According to an embodiment of the invention, the elimination means is an electrical coil wrapped on barbed studs.

In another aspect the catalyst is selected from the group consisting of: bubbles or solid rings/plates catalyst, a platinum substrate on an alumina, carbon platinum, titanium dioxide, or any combination thereof, or any combination of catalysts.

According to an embodiment of the invention, the enclosure of the hot reactor is made from a heat conductive metal such as copper or nickel.

According to some embodiment of the invention, the mosquito trap and component thereof are designed with non-cylindrical shape.

In yet another aspect, the elimination module further comprises one or more liquid odorant compartments, from each of which a capillary stick extends, and spreads a mosquito-attracting odor.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1A schematically illustrates a section view of a mosquito trap, according to an embodiment of the present invention;

FIG. 1B schematically illustrates a chimney of a mosquito trap, according to an embodiment of the present invention;

FIGS. 2A-2B schematically illustrate a reactor unit 20 of a mosquito trap according to an embodiment of the present invention;

FIG. 3A schematically illustrates a section view of a mosquito trap, according to an embodiment of the present invention; and

FIG. 3B illustrate a partial perspective view of the mosquito trap of FIG. 3A.

### A DETAILED DESCRIPTION OF EMBODIMENTS OF THE INVENTION

The present invention relates to a smart and environmental friendly (Eco-friendly) mosquito trap that is adapted to induce sufficient environmental conditions such as to simulate the near environment of a human body (e.g., CO2 emission humidity and warmth), while stimulating mosquitos to prefer approaching the proposed mosquito trap over a nearby residing humans.

The proposed mosquito trap employs an Eco-friendly chemical reaction between an alcohol-based liquid (e.g., methanol or alcohol equivalent) and oxygen being preliminary triggered by heating, and accelerated by suitable catalyst and chimney effect. The reaction products are CO₂, water vapors and heat being dispersed to effectively simulate the environment of a human body that was found to attract mosquitos. Subsequently, a common electrical coil, or other suitable means can be used to eliminate the attracted mosquitos.

According to some embodiments of the invention, complementary odor induction means are utilized to intensify the mosquito's attraction, and hence, to stimulate mosquitos to prefer approaching the proposed mosquito trap over nearby residing humans.

In the following detailed description, references are made to several embodiments of the present invention, examples of which are illustrated in the accompanying figures. The figures depict an embodiment of the present invention for purposes of illustration only. One skilled in the art will readily recognize from the following description that the described embodiments may be combined, alternative embodiments may be utilized, and other changes may be made without departing from the spirit or scope of the present invention described herein.

One of the main advantages of the present invention is the fact that the mosquito trap is based on a reactor that generates an environment with heat, CO2, water vapors and odors that highly attract mosquitos and causes them to prefer the generated environment, rather than a human body. This is done solely by a chemical reaction, without requiring any supply of electricity.

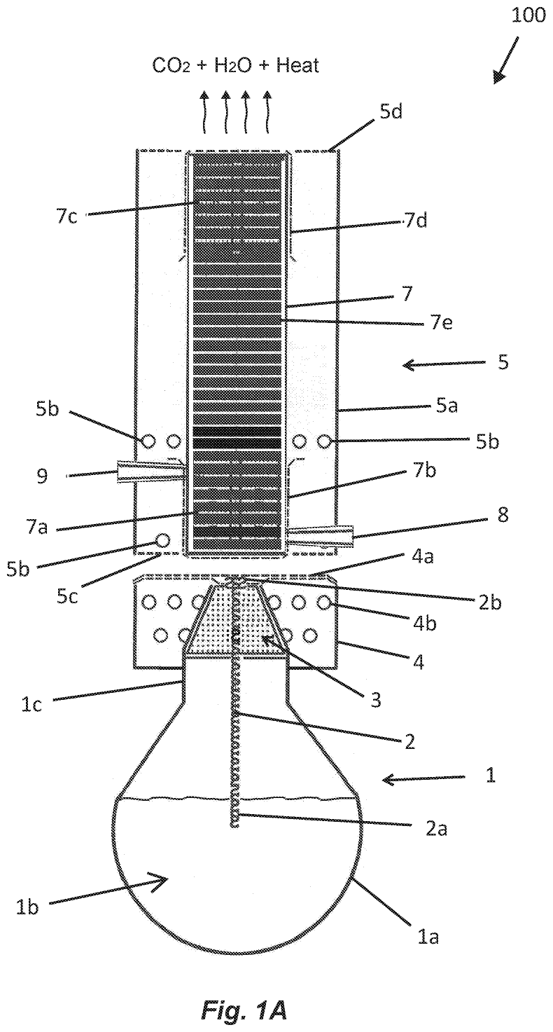

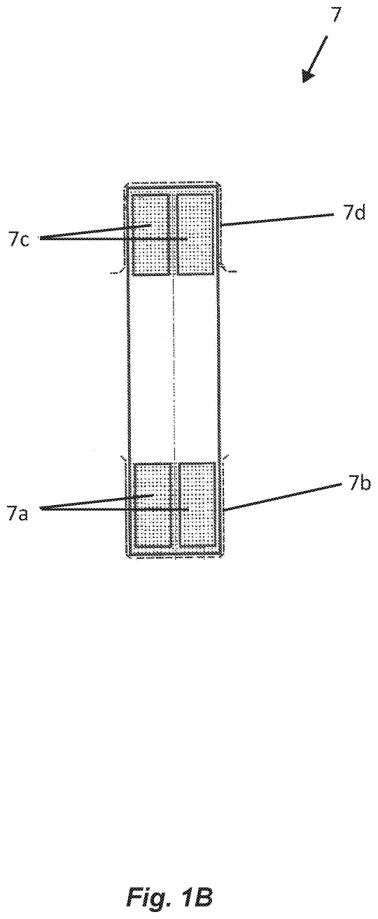

FIG. 1A schematically illustrates a section view of a mosquito trap 100, according to an embodiment of the invention. Mosquito trap 100 comprises a container 1 adapted with a lower portion 1a containing an alcohol-based liquid 1b (e.g., methanol) and a narrower top portion 1c in which a capillary transmission means such as a capillary stick 2 (i.e., comprising capillary material such as a cotton wrapped stick, or any other capillary means) is affixed within a sealing sponge 3 (i.e., for preventing alcohol-based liquid spilling from container 1) and extends downwardly, such as that its bottom end 2a is immersed in the alcohol-based liquid 1b to a determined extent, and its top-end 2b, which is wet with capillary transmitted alcohol-based liquid, protrudes upwardly and being limited by a mesh 4a of a lid 4, which is detachably connected to container 1 (e.g., for re-fill purpose). Lid 4 further comprises circumferential inlet holes 4b that enable ambient airflow into mosquito trap 100 as described in details hereinafter.

Sponge 3 may be detachably attached at the top end of top portion 1c, such as to hold stick 2 centralized within container 1, where the immersed end 2a of capillary stick 2 absorbs alcohol-based liquid 1b that flows towards the protruding top end 2b of stick 2, in contact with mesh 4a, through which vaporized alcohol-based liquid 1b and incoming airflow upwardly into a hot reactor 5.

Hot reactor 5 comprises an enclosure 5a adapted with peripheral air inlet holes 5b, a lower closure inlet mesh 5c, a top outlet mesh 5d, and a substantially hollow reaction chimney 7, which is centrally positioned within reactor 5 and adapted with radial lower inlet apertures 7a covered with net 7b and upper outlet apertures 7c covered with net 7d (further illustrated in FIG. 1B). Chimney 7 comprises a suitable catalyst 7e (e.g., in the form of bubbles, powder, solid rings/plates, round discs, plates, a platinum substrate on an alumina, carbon platinum, titanium dioxide, or any combination thereof) suitable to accelerate the reaction of alcohol-based liquid 1b and air. Catalyst 7e is securely enclosed within chimney 7 by nets 7b and 7d.

Container 1 and reactor 5 are illustrated in FIG. 1 as being separated for the sake of clarity, however, whereas mosquito trap 100 is active, container 1 and reactor 5 are detachably connected together, for instance, by an external threaded or pressed ring, or an alternate detachable connection.

Further shown in FIG. 1A are a heating module 8 (e.g., a ceramic element adapted with a low voltage heating element and with suitable power supply and wiring thereof) and a temperature sensing/switching module 9 (e.g., a thermocouple switching element adapted to stop the power supply to heating module 8 upon reaching a predetermined target temperature). The heating module 8 and the temperature sensing/switching module 9 are electrically controlled by a controller that terminates the operation of the heating module 8 upon detecting that the reaction has been initiated. Of course, multiple alternate temperature-controlled arrangements may be selected by one skilled in the art for providing limited heating of the lower portion of chimney 7 until initiating temperature the desirable reaction between vapors of alcohol-based liquid 1b and oxygen.

The operation of mosquito trap 100 begins with the powering of heating module 8 which exerts sufficient heat (of at least 100° C.) at the lower portion of chimney 7. Vapors of alcohol-based liquid 1b that flow upwardly through mesh 4a and inlet net 7a into the heated lower portion chimney 7, together with the oxygen of the incoming air (i.e., through-holes 4b and mesh 4a) begins to react as the target temperature is reached (i.e., as sensed by sensing/switching module 9 which powers off the heating module 8). The initiated reaction is being accelerated by catalyst 7e. The reaction products are substantially consisting of carbon dioxide, humidity, and heat. For example, where alcohol-based liquid 1b is methanol, the reaction can be described by the following formula:

2CH3OH+3O2 [symbol] 2CO2+4H2O+heat

The hot reaction products flow up through chimney 7 and outlet mesh 5d, as well as through apertures 7c, net 7d and mesh 5d, resulting in a chimney effect that draws in further air through apertures 7a (i.e., incoming through-holes 4b, mesh 4a and holes 5b that are used to cool the chimney 7 and the body of the hot reactor 5 (which are heated by the reaction). The hot air that flows through-holes 5b and evacuates the heat from the chimney 7 and the body of the hot reactor 5 is used later to heat liquid odorants that attract mosquitos, as will be described later on.

According to some embodiments, enclosure 5a is made of a heat conductive metal (e.g., nickel or copper), such as to improve the heat dispersion from chimney 7 to the ambient environment.

The abovementioned operation of mosquito trap 100 enables a low-power consumption and an Eco-friendly production of the mosquito-attracting ingredients in the ambient environment of a human body.

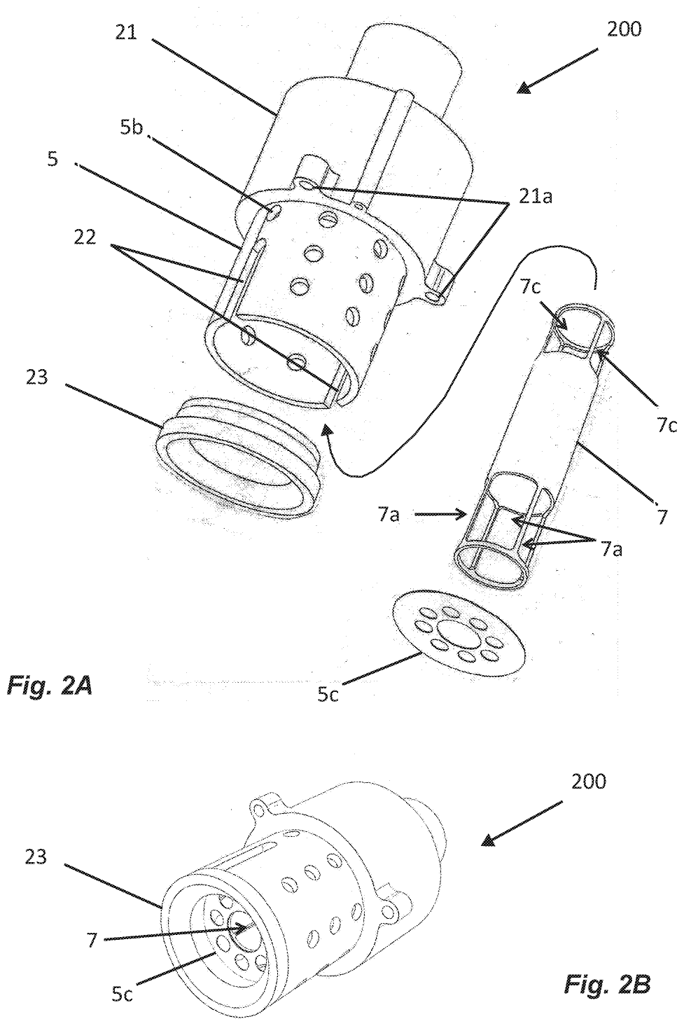

FIGS. 2A-2B schematically illustrate a reactor unit 20 of a mosquito trap 200, according to an embodiment of the invention. Reactor unit 20 comprises a base 21 adapted with fastening holes 21a for attaching reactor 5 in mosquito trap 200, wherein reactor 5 (of FIG. 1A) is installed within base 21 and mesh 5c enclosing chimney 7 in reactor 5. Further shown in FIGS. 2A-2B are assembly apertures 22, utilized for installing heating module 8 and sensing/switching module 9 with reactor 5, and an attachment ring 23 adapted to stable enclose chimney 7 within reactor 5 (i.e., in conjunction with mesh 5c), as well as to connect reactor 5 with container 1 and lid 4 thereof (FIG. 2B illustrates reactor unit 20 in its assembled state.

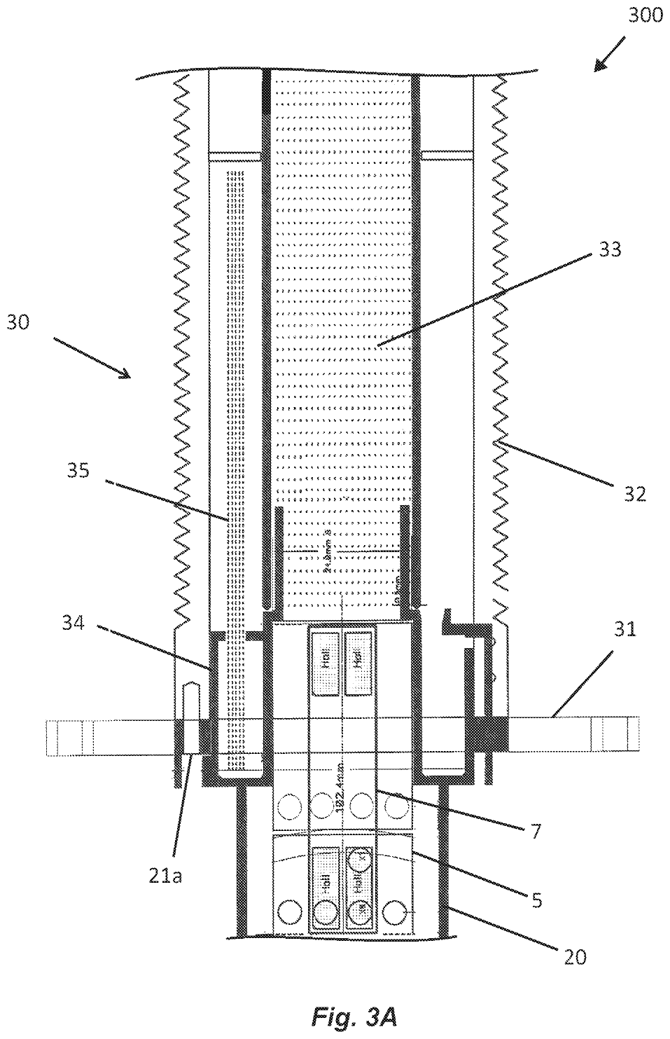

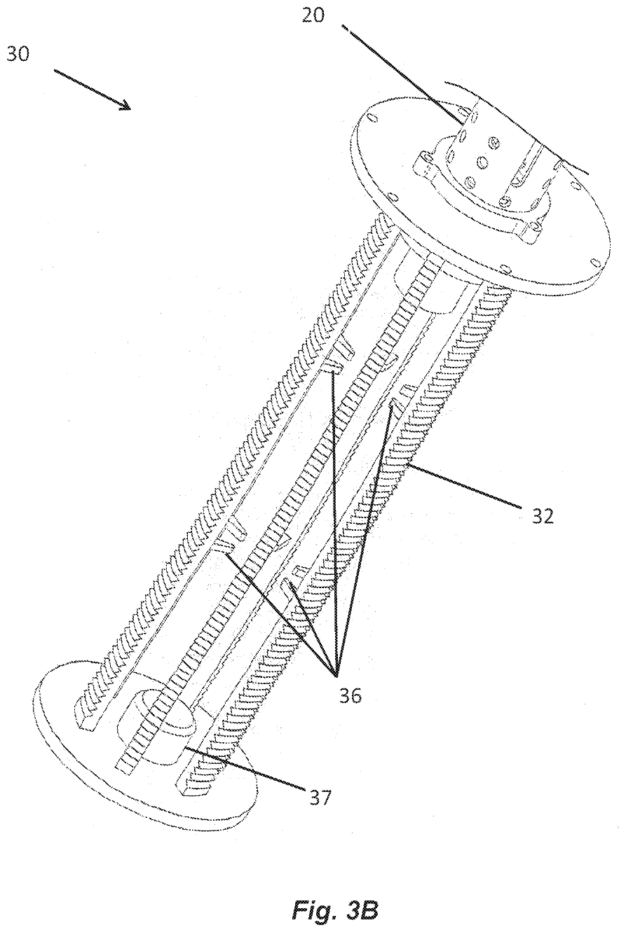

FIG. 3A schematically illustrates a section view of a mosquito trap 300, according to an embodiment of the invention. Mosquito trap 300 comprises a mosquito elimination module 30 and a reactor unit 20, where elimination module 30 comprises a base, to which reactor unit 20 is attached (e.g., by bolts threaded through fastening holes 21a), barbed studs 32 to which an electric coil/mesh (not shown) is anchored, and a dispersion sleeve 33 being in communication with outlet mesh 5d of reactor 5. A partial perspective view of elimination module 30 is shown in FIG. 3B, which also illustrates stabilizing studs 36 and base 37 for stably holding dispersion sleeve 33.

Whereas mosquito trap 300 is active, reaction products are emitted from reactor 5 enclosing chimney 7 into dispersion sleeve 33 (i.e., which enables uniform dispersion of the reaction products) and therefrom to the ambient environment. Nearby mosquitos that are attracted by the emitted reaction products approaches towards dispersion sleeve 33, contacts electric coil/mesh, and being eliminated.

According to an embodiment of the invention, elimination module 30 further comprises one or more liquid odorant compartments 34 from each of which a capillary stick 34 extends upwardly, and spreads a highly attractive odor, such as described in Mukabana et al., (J Chem Ecol (2012) 38:235-244), Smallegange et al., (Chem. Senses 30: 145-152, 2005), and Robinson et al., (PNAS May 1, 2018 115 (18) E4209-E4218). The dispersion of such odorants may stimulate nearby mosquitos to prefer approaching the proposed mosquito trap over nearby residing humans.

Although embodiments of the invention have been described by way of illustration, it will be understood that the invention may be carried out with many variations, modifications, and adaptations, without exceeding the scope of the claims. For example, while mosquito traps 100 and 300 hereinabove may be illustrated as having a substantially cylindrical shape, an alternate embodiment may utilize different non-cylindrical shapes and designs.

1. A mosquito trap emulating an environment of a human body, comprising:
a) a container configured with:
i) a lower portion containing liquid methanol;
ii) an uncovered or permeable top portion;
iii) one or more first capillary sticks affixed within, and extending downwardly from, said top portion so as to be capable of being immersed in the contained methanol and of transmitting the methanol to said top portion through capillarity to ensure that said top portion is wet with the capillary transmitted methanol; and
iv) a lid detachably connected to said lower portion or said top portion, wherein the lid is configured with circumferential inlet holes through which incoming ambient airflow is flowable to vaporize the wet capillary transmitted methanol;
b) a reactor connectable with said container which comprises an enclosure configured with peripheral air inlet holes through which incoming ambient airflow including oxygen is flowable into an interior of said reactor to facilitate a chemical reaction with the methanol vapors which are upwardly flowable into the reactor interior, wherein the chemical reaction produces carbon dioxide, water and heat;
c) a chimney centrally positioned within said reactor, wherein the chimney is configured with lower apertures in communication with an outlet of said reactor and with upper apertures through which heated reaction products are discharged, an upward flow of the heated reaction products causing additional ambient air to be drawn through the lower apertures by a chimney effect to cool said reactor and the chimney and to ensure that additional heated reaction products will be continuously produced;
d) an initiating unit for providing sufficient heat influx to said reactor to trigger the chemical reaction and for terminating the heat influx upon detecting that the chemical reaction has been initiated; and
e) an elimination module attachable to said reactor, comprising:
i) a permeable or apertured upwardly extending dispersion sleeve which receives the heated reaction products upwardly flowing from said reactor;
ii) one or more compartments containing liquid odorant that is each provided with a corresponding upwardly extending second capillary stick horizontally spaced from said dispersion sleeve to transmit the odorant through capillarity, wherein the capillarity transmitted odorant is heatable by the heated reaction products dispersed from said dispersion sleeve to produce mosquito-attracting, odorant bearing heated reaction products;
iii) a structure horizontally spaced from each of the second capillary sticks that is configured with a plurality of openings through which the odorant bearing heated reaction products are emitted to induce a mosquito-attracting ambient environment; and
iv) an electric elimination means mounted on said structure for eliminating mosquitos attracted to the induced environment upon engaging said elimination means.

2. The mosquito trap according to claim 1, wherein the initiating unit comprises a heating module for heating the reactor, and a sensing/switching module for deactivating said heating module upon reaching a predetermined temperature.

3. The mosquito trap according to claim 1, wherein each of the one or more first capillary sticks is a cotton wrapped stick.

4. The mosquito trap according to claim 1, wherein each of the first capillary sticks is affixed in a sealing sponge for preventing spillage of methanol from the container which is attached to the top portion of the container.

5. The mosquito trap according to claim 4, wherein a top end of each of the first capillary sticks or strings that is wet with the capillary transmitted methanol protrudes upwardly from the sealing sponge and is limited by a mesh of the lid through which the methanol vapors upwardly flow into the reactor interior.

6. The mosquito trap according to claim 1, wherein the elimination means comprises an electrical coil.

7. The mosquito trap according to claim 1, wherein the chimney is provided with a catalyst that is suitable for accelerating the chemical reaction between vaporized alcohol-based liquid from the container and oxygen from the incoming ambient air.

8. The mosquito trap according to claim 7, wherein the catalyst is selected from the group consisting of: bubbles or solid rings/plates catalyst, a platinum substrate on an alumina, carbon platinum, titanium dioxide, or any combination thereof.

9. The mosquito trap according to claim 1, wherein the enclosure of the reactor is made from a heat conductive metal.

10. The mosquito trap according to claim 1, which has a cylindrical or non-cylindrical shape.

11. The mosquito trap according to claim 1, wherein the reactor is configured with a lower inlet mesh through which the methanol vapors are upwardly flowable into the reactor interior, and with a top outlet mesh through which the heated reaction products are upwardly flowable into the chimney.

12. The mosquito trap according to claim 1, wherein the dispersion sleeve is tubular and the structure is curved so as to be radially spaced outwardly from the dispersion sleeve and to define an annulus within which each of the corresponding upwardly extending second capillary sticks upwardly extends.

13. The mosquito trap according to claim 12, wherein the structure is configured with a plurality of arcuate and circumferentially spaced studs.
